(19) United States
(12) Patent Application Publication
(10) Pub. No.: US 2011/0166845 A1
(43) Pub. Date: Jul. 7, 2011

(54) METHOD FOR THE QUALITY ASSESSMENT OF NUCLEIC ACID AMPLIFICATION REACTIONS

(75) Inventors: Christian Von Törne, Solingen (DE); Mareike Assink, Koln (DE); Udo Stropp, Haande (DE)

(73) Assignee: SIVIDON DIAGNOSTICS GMBH, Koln (DE)

(21) Appl. No.: 13/061,797

(22) PCT Filed: Jul. 16, 2009
(86) PCT No.: PCT/EP09/59179

§ 371 Date: Mar. 2, 2011

(30) Foreign Application Priority Data
Sep. 2, 2008 (EP) 08015475.0

(51) Int. Cl. G06G 7/58

(52) U.S. Cl. 703/12

(57) ABSTRACT

The invention relates to a method for the quality assessment of nucleic acid amplification reactions which is based on a mathematical approach for the quality assessment of complete nucleic acid amplification reactions and comprises the following steps: a) Carrying out an amplification reaction for at least one nucleic acid target molecule, b)Collecting time-related data reflecting the course of the amplification reaction, c) Fitting these time-related data with a growth model equation comprising at least one parameter, d) Obtaining, from said fitting process, at least one value for the at least one parameter.

### FIELD OF THE INVENTION

The present invention relates to methods for the quality assessment of nucleic acid amplification reactions.

### BACKGROUND OF THE INVENTION

Nucleic acid amplification reactions, particularly Polymerase Chain Reactions (PCR), are methods to detect minute concentrations of nucleic acids in samples by step-wise exponential amplification of a specific target.

While quantification with this method is possible, the reaction is easily influenced by a number of error sources, e.g. reagent variations, target contamination, failure of the detection instrument, suboptimal primer and/or probe design, failure of the polymerase enzyme, other non-foreseeable errors during the amplification recordings and the like.

When plotting data reflecting the course of the amplification experiment vs. time, one obtains a so-called “PCR curve”, which is characterized by three phases, namely:
1. Initial phase: In this phase, a signal generated by the number of copies produced in the amplification process is still so small that it is not yet detectable, due to background noise, limited detector sensitivity and the like. For this reason, there is no detectable increase of target molecule concentration over background in the sample in this phase.
2. (optional) Exponential phase: In this phase, the signal generated by the number of target amplicon copies produced in the amplification process is detectable above background noise. The signal grows exponentially, as, because of the nature of the amplification process, the number of copies is doubled in each cycle. In a logarithmic plot, this phase would be reflected by a straight line.
3. (optional) Saturation phase: In this phase, the signal generated by the number of copies produced in the amplification process (and, thus, the number of copies reaches a steady state as the reaction comes to an end. This may, for example, be due to exhaustion of substrates, or depletion of the polymerase enzyme as caused by repeated heating and cooling in the amplification process.

In some cases the reaction is halted earlier, e.g. due to low or absent initial target molecule concentration or too low a number of cycles in the PCR reaction. This means that in these cases the saturation phase or even the exponential phase may not be reached.

A good curve
(i) has a good signal-to-noise ratio (S/N) which allows proper differentiation between signals and noise; and
(ii) allows for a good identification of the said phases.

Bad curves, which may be caused by one or more of the above error sources, e.g. have jagged peaks, crawling growth curves or other abnormalities. Examples are given in the figures.

Quality control in nucleic acid amplification reactions, particularly PCR, can be divided into three categories, i.e.
(i) external quality control,
(ii) internal quality control, and
(iii) amplification quality control.

External controls are used to control amplification conditions, instrument parameters, reagents, ambient conditions and the like. Usually, external controls are synthetic samples (synthetic oligonucleotides specific to the amplification process), nucleic acids from reference samples, cell lines, or mixtures of mRNA/cDNA from a plurality of sources (in-house RNA/DNA pools, reference RNA provided by companies for this specific purpose, such as Universal Reference Total RNA as provided by Clontech.

The idea behind this approach is that if conditions of a specific PCR run are adequate, the concentration of the intended target in a well-investigated external control sample is expected within a certain range which is determined beforehand.

External quality control uses separate wells with defined target properties and the reagents used on the actual samples.

The use of external controls is also proposed by the US Food & Drug Administration (FDA) MAQC program (Micro Array Quality Control), making it a de-facto standard in such experiments.

A special case of external controls is the “no template control” (NTC), in which no template (sample DNA/RNA) is pipetted into the well of the microtiter plate while all reagents needed for the amplification reaction are present. It is expected that no signal can be detected in these controls, as there is no signal-generating template, or target in the control.

If a signal is yet detectable, this is an indicator for the presence of contamination of one of the reagents, or undesired properties of the primer/probes (instability, self-synthesis by hairpin loops, dimerization, etc.)

Internal controls are used to assess specific traits of the sample under investigation, such as presence, absence or amount of nucleic acids in the well, or the expression value of specific targets as correlates. They are used to ensure that the sample at hand is valid for analysis. This approach uses actual samples in a separate well, or fluorescence channel (if a multiplexing approach is used).

The two approaches mentioned above have some underlying assumptions:

For external controls, it is assumed that, if the reagents/conditions are acceptable for the external control, they are acceptable for all wells with sample targets as well.

For internal controls, if measurement of one specific target is acceptable in one well, the measurement of a different target in the same sample but in a different well is also acceptable.

These assumptions do however not account for all possible error sources, for example if there are amplification problems for whatever reason in a single well, or in a number of wells which measure (assumed identical) replicates of the same sample and the same target.

In order to solve this problem, it is common laboratory practice that an experienced operator revises a given PCR curve visually and assesses, on the basis of the S/N and identifiability of the said phases, combined with his own experience, whether to discard the experiment or not (“visual curve inspection”).

This approach, although widely accepted, is of course subject to a non-objectiveness, as the decision process is not standardized, but subject to training, experience, or personal preference of the respective operator, and thus inherently irreproducible. Furthermore, the process is time consuming, and thus not suitable for high throughput approaches.

Some manufacturers provide automatic solutions for said quality assessment in order to accelerate the quality control process, and make it more objective. Applied Biosystems Inc, Forster City, USA, have a software solution (SDS Software Version 2.3) for use with the ABI PRISM range of instruments which is claimed to detect a number of different errors in amplification.

However, the inventors have found that some PCR curves which were classified by the said automatic solutions as successful would not pass the visual curve inspection, as S/N was poor high and/or the different phases could not be identified (see FIG. 2a). This means that the approach offered by the SDS Software is no real substitute to visual curve inspection, as it lets pass bad curves which are obviously influenced by one or more of the above error sources.

PCR is yet a method often used in critical applications, such as molecular diagnostics, forensics and the like. As such, results with poor quality may for example adversely impact the diagnostic or therapeutic decision made, which in turn may be harmful for the patient. This means that the hit rate of this approach is not satisfying.

In WO2006014509 a quantitative PCR data analysis system is disclosed, which allows the caluclation of a C_{T}-Value, i.e. a fractional cycle number at which a PCR related signal, which may be plotted as a curve, rises above a threshold, namely by means of a processor which computes a Local Quality Value (LQV) for each local region of the curve. While this method provides a mathematical approach for PCR curve evaluation, it only allows for quantification (i.e. C_{T}-Value determination), but not for quality assessment.

Guescini et al. (2008) have described a new real-time PCR method to overcome significant quantitative inaccuracy due to slight amplification inhibition. Again, this approach is directed to the quantification of PCR experiments i.e. C_{T}-Value determination), but not to quality assessment.

### OBJECT OF THE INVENTION

It is thus the object of the present invention to provide a method for the quality assessment of nucleic acid amplification reactions, which provides for a quick determination of the quality of the reaction.

It is another object of the present invention to provide a method for the quality assessment of nucleic acid amplification reactions, which provides a better hit rate as related to methods known from the art.

It is another object of the present invention to provide a method for the quality assessment of nucleic acid amplification reactions, which has a higher degree of reproducibility than methods known from the art.

### SUMMARY OF THE INVENTION

Before the invention is described in detail, it is to be understood that this invention is not limited to the particular component parts of the devices described, instruments or process steps of the methods described as such devices and methods may vary. It is also to be understood that the terminology used herein is for purposes of describing particular embodiments only, and is not intended to be limiting. It must be noted that, as used in the specification and the appended claims, the singular forms “a,” “an” and “the” include singular and/or plural referents unless the context clearly dictates otherwise. It is moreover to be understood that, in case parameter ranges are given which are delimited by numeric values, the ranges are deemed to include these limitation values.

According to the invention, a method is provided for the quality assessment of nucleic acid amplification reactions, comprising the following steps:
a) Carrying out an amplification reaction for at least one nucleic acid target molecule,
b) Collecting time-related data reflecting the course of the amplification reaction,
c) Fitting these time-related data with a growth model equation comprising at least one parameter,
d) Obtaining, from said fitting process, at least one value for the at least one parameter.

The inventors of the present invention have, for the first time, presented herein a mathematical approach for the quality assessment of complete nucleic acid amplification reactions which provides an objective basis for quality control, as it assumes, for the first time that the time course of a PCR curve adopts the bahavior of a parametric function, and can thus be fitted with a suitable mathematical equation.

The said approach
(i) is thus faster than visual curve inspection
(ii) has a better hit rate than automated methods known from the art, and
(iii) has a better reproducibility when compared to visual curve inspection and automated methods known from the art, and thus
(iv) offers a higher reliability and reproducibility, particularly in diagnostic applications.

The term “fitting”, as used herein (also termed “curve fitting”), relates to a process of finding a mathematical representation which best reflects the course (e.g. the time course) of a series of data points.

The idea behind this approach is the assumption that data points measured in an experiment, or in an empirical data collection process, do often reflect a process governed by natural laws, and can thus be described by a mathematical equation.

Curve fitting can be done by interpolation, regression analysis or as part of an optimization process (e.g. maximum likelihood approach). It can be envisioned as the recovery of the parameters in a given model underlying noisy measurements.

The term “quality assessment”, as used herein, relates to a quality control process in order to assess whether or not a PCR curve might be classified as acceptable (i.e. not distorted by errors).

The term “growth model function”, as used herein, relates to a mathematical function which represents a model for growth phenomena in biology, ecology, or other sciences. They usually map a point in time to a scalar quantity characteristic for growth (size, area, cell count, or, as in the case of the present invention, signal intensity). These models typically exhibit a monotonously increasing behaviour, that is, the function has higher values for later points in time compared to earlier points in time. Depending on the nature of the characteristic quantity, growth model functions can have continuous or discrete values.

The term “parameter” as used herein, relates to a quantity that defines certain characteristics of an equation. These quantities define the general shape and other properties of the mathematical function they are associated with and, as such, are typically determined before evaluating the associated function.

The term “nucleic acid target molecule”, as used herein, relates to oligonucleotides and polynucleotides which are subject of the amplification process. The latter may, for example, be selected from the group consisting of
DNA, particularly cDNA
RNA, like mRNA, miRNA, t-RNA and other ribonucleic acids forms

The term “time-related data reflecting the course of the amplification reaction”, as used herein, relates to data that reflect the time-related concentration of the nucleic acid target molecules, e.g. in a step-wise amplification process over time.

It is a common fact that nucleic acid amplification reactions are subject to exponential increase of the number of molecules to be amplified (“target molecule concentration”), namely due to the nature of the said reaction, in which the number of copies is doubled in each cycle. One can, in a nucleic acid amplification experiment, determine, in most cases, three phases as mentioned above.

If all phases are present, the time-related data reflecting the course of the amplification reaction will adopt a sigmoidal shape when plotted vs. time (see FIGS. 1 and 3).

However, if the reaction is halted earlier, e.g. due to low or absent initial target molecule concentration or too low a number of cycles in the PCR reaction, the saturation phase will not be reached, and the time-related data reflecting the course of the amplification reaction will adopt the shape of an exponential function when plotted vs. time.

In a preferred embodiment, the method according to the invention further comprises the steps of
e) comparing the at least one value of the at least one parameter with at least one threshold value for the at least one parameter, and
f) determining, on the basis of step e), whether or not the said nucleic acid amplification reaction meets at least one quality criterion

Step f) can be accomplsished, in a preferred embodiment, by comparison of said one or more parameters or combinations thereof with pre-determined typical values or ranges.

The term “quality criterion”, as used herein, relates to a mathematical criterion which determines whether or not a nucleic acid amplification reaction is subject to artifacts and/or errors, as for example caused by any of the above error sources.

In another preferred embodiment, the method according to the invention further comprises the step of
b1) determining, between steps b) and c), whether or not the time-related data collected do at all reflect a growth.

In this approach, it is checked whether or not there is a significant increase of time-related data over time, which might reflect a limited or non-limited growth of target nucleic acid as produced by a nucleic acid amplification process. If not, it is assumed that there the nucleic acid amplification reaction was not successful at all, and the curve fitting approach as outlined above is not necessary. Therefore, this approach serves as a basic control whether or not there is an amplification-related signal at all.

See FIG. 5. and the respective description for an example for this approach.

It is particularly preferred that the nucleic acid amplification reaction is at least one reaction selected from the group consisting of
Real time Polymerase Chain reaction,
reverse transcription Polymerase Chain Reaction,
Ligase Chain Reaction (LCR),
Nucleic Acid Sequence Based Amplification (NASBA),
Transcription Mediated Amplification (TMA),
Rolling Circle Chain Reaction (RCCR), or Rolling circle
Amplification (RCA) and/or
other kinetic or quantitative amplification reactions with real time read-out.

The term “real time read-out”, as used herein, refers to atzhe possibility to simultaneously monitor the time course of the experiment, i.e. in real time, preferably by monitoring the number of synthesized copies. For this purpose, dyes or other quantifiable measures may be used.

The methods mentioned above are methods for the detection and amplification of nucleic acids, which have in common that they are cyclic methods. The number of copies produced is dependent on the number of cycles, often in an exponential relationship.

While Polymerase Chain reaction and its derivatives, and Ligase Chain Reaction are thermocyclic methods, the remaining methods are isothermal.

Real time PCR, also termed quantitative PCR (qPCR) or kinetic PCR (kPCR), is a laboratory technique based on the polymerase chain reaction, which is used to amplify and simultaneously quantify a nucleic acid target molecule. It enables both detection and quantification of a specific nucleic acid target molecule.

The procedure follows the general principle of polymerase chain reaction; its key feature is that the amplified DNA is quantified as it accumulates in the reaction in real time after each amplification cycle. Two common methods of quantification are the use of fluorescent dyes that intercalate with double-stranded nucleic acids, and modified oligonucleotide probes that fluoresce when hybridized with a complementary nucleic acid.

The latter approach uses a sequence-specific nucleic acid probe to quantify only the amplified nucleic acid target molecules containing the probe sequence; therefore, use of the reporter probe significantly increases specificity, and allows quantification even in the presence of some non-specific DNA amplification.

Other techniques are special probe designs like
“Scorpion probes”, i.e. highly sensitive, sequence-specific, bi-labeled fluorescent probe/primer hybrids designed for real-time quantitative PCR, as provided by DxS Ltd,
“molecular beacons”, i.e. single stranded hairpin shaped oligonucleotide probes comprising a loop and two stems being equipped with a 5′ fluorophore and a 3′ quencher which, in the presence of the target sequence, unfold, bind and start to fluoresce. These probes are being provided by Public Health Research Institute Properties, Inc.
LNA (locked nucleic acids)-based probes, i.e modified RNA nucleotides in which the ribose moiety of an LNA nucleotide is modified with an extra bridge connecting the 2′ and 4′ carbons. Theses nucleotides are, e.g., incorporated into TaqMan-probes (see below) to provide extra stability.

The said approach is commonly carried out with probe having a fluorescent reporter at one end and a quencher of fluorescence at the opposite end of the probe. The close proximity of the reporter to the quencher prevents detection of its fluorescence due to fluorescence resonance energy transfer (FRET). The breakdown of the probe by the 5′ to 3′ exonuclease activity of the Taq polymerase used in the amplification process breaks the reporter-quencher proximity and thus allows unquenched emission of fluorescence, which can be detected (so called “Taq-Man” approach). An increase in the product targeted by the reporter probe at each PCR cycle therefore causes a proportional increase in fluorescence due to the breakdown of the probe and release of the reporter. Reverse transcription polymerase chain reaction (RT-PCR) is a laboratory technique for amplifying a defined piece of a ribonucleic acid molecule, for example an mRNA. The (m)RNA strand is first reverse transcribed into its (c)DNA complement by means of a reverse transcriptase enzyme. The DNA thus obtained is then subjected to a conventional PCR reaction, preferably a real time PCR reaction as outlined above. This can either be a one- or two-step process.

Reverse transcription polymerase chain reaction is a useful tool for detecting the presence or absence of pathogens, like viruses, or the gene expression profile of a target gene. The approach allows, furthermore, the quantification of the amount of target RNA in the sample.

Further developments, and thus comprised by the term “Real time PCR” as used herein, are ImmmunoPCR and nested PCR, 1-step PCR, 2-step PCR and/or multiplex PCR. The person skilled in the art will as well realize that the teaching of the present invention is also applicable to other further developments of Real Time PCR, without the need of inventive step.

Ligase Chain Reaction (LCR) is a method of DNA amplification similar to PCR. LCR differs from PCR because it amplifies the probe molecule rather than producing amplicon through polymerization of nucleotides. Two probes are used per each DNA strand and are ligated together to form a single probe. LCR uses both a DNA polymerase enzyme and a DNA ligase enzyme to drive the reaction. Like PCR, LCR requires a thermal cycler and each cycle results in a doubling of the target nucleic acid molecule. LCR can have greater specificity than PCR.

Nucleic Acid Sequence Based Amplification (NASBA) is a method in molecular biology which is used to amplify RNA sequences. Therein, a target RNA template is given to the reaction mixture, and a first primer attaches to its complementary site at the 3′ end of the template. Then a reverse transcriptase synthesizes the complementary DNA strand. RNAse H destroys the RNA template, and a second primer is attached to the 5′ end of the DNA strand. T7 RNA polymerase produces then a complementary RNA strand which can be used again as template, so this reaction is cyclic.

Transcription mediated amplification (TMA) is an isothermal nucleic-acid-based method that can amplify RNA or DNA targets a billion-fold in less than one hour's time. It uses two primers and two enzymes: RNA polymerase and reverse transcriptase. One primer contains a promoter sequence for RNA polymerase. In the first step of amplification, this primer hybridizes to the target rRNA at a defined site. Reverse transcriptase creates a DNA copy of the target rRNA by extension from the 3′end of the promoter primer. The RNA in the resulting RNA:DNA duplex is degraded by the RNase activity of the reverse transcriptase. Next, a second primer binds to the DNA copy. A new strand of DNA is synthesized from the end of this primer by reverse transcriptase, creating a doublestranded DNA molecule. RNA polymerase recognizes the promoter sequence in the DNA template and initiates transcription. Each of the newly synthesized RNA amplicons reenters the TMA process and serves as a template for a new round of replication. The amplicons produced in these reactions are detected by a specific gene probe in hybridization protection assay, a chemiluminescence detection format.

Rolling circle DNA amplification (RCA) is based on the so called Rolling circle replication, which is initiated by an initiator protein encoded by the plasmid or bacteriophage DNA, which nicks one strand of the double-stranded, circular DNA molecule at a site called the double-strand origin, or DSO. The initiator protein remains bound to the 5′ phosphate end of the nicked strand, and the free 3′ hydroxyl end is released to serve as a primer for DNA synthesis by DNA polymerase III. Using the unnicked strand as a template, replication proceeds around the circular DNA molecule, displacing the nicked strand as single-stranded DNA. Displacement of the nicked strand is carried out by a host-encoded helicase called PcrA (the abbreviation standing for plasmid copy reduced) in the presence of the plasmid replication initiation protein.

It is, furthermore, particularly preferred that the growth model is at least one selected from the group consisting of
non-limited growth models and/or
limited growth models.

As mentioned before, the number of copies of the target molecules is doubled in each cycle in a nucleic acid amplification reaction. This behaviour is best reflected by either a non-limited growth model (especially in the exponential phase), or a limited growth model (especially if the saturation phase is modelled).

In a non-limited growth model, the growth is not limited, i.e. it can be described by e.g. a simple exponential function. Such a model may for example be used in case the nucleic acid amplification reaction is halted before the substrates are exhausted, or the polymerase enzyme is depleted.

In a limited growth model, the exponential growth is limited by some factors, e.g. due to exhaustion of substrates, or depletion of the polymerase enzyme as caused by repeated heating and cooling in the amplification process. Such growth can often be described by a sigmoidal curve, or sigmoidal equation, which has an initial phase, an exponential phase, and a saturation phase.

The most common sigmoidal equation is a so-called logistic equation, which can be formulated as

$$f ( t ) = \frac{a}{1 + b \cdot {e}^{- c \cdot t}} \qquad ( Equation 1 )$$

In the case at hand, it is a preferred embodiment that all sigmoid functions such as this in addition allow for some background, preferably modelled by a linear function,

$$f ( t ) = \frac{a}{1 + b \cdot {e}^{- c \cdot t}} + d + f \cdot t \qquad ( Equation 2 )$$

where d,f are parameters for a possible background signal that need to be fit to the given data either simultaneously or in a separate estimation.

Curves of this type have a symmetrical shape when being plotted, i.e. the transition between the initial phase and the exponential phase, and the transition between the exponential phase and the saturation phase, have the same shape (although rotated by 180° around the point of inflexion).

However, as, in nucleic acid amplification experiments, the transition between the initial phase and the exponential phase has a different technical, biochemical, and/or biological background than the transition between the exponential phase and the saturation phase, the shapes of both might very well differ from one another.

In a preferred embodiment, therefore, the limited growth model is a non-symmetrical limited growth model, which allows for different shapes of (i) the transition between the initial phase and the exponential phase, and (ii) the transition between the exponential phase and the saturation phase, and is thus capable of accounting for the different technical and/or biochemical and/or biological background of the two transition phases, as mentioned above.

It is particularly preferred that the limited growth model is based on at least one algorithm selected from the group consisting of
Gompertz equation (see equation 5, and e.g. Yin et al, 2003),
Arcus tangens and/or Tangens Hyperbolicus (as known to the person skilled in the art from standard mathematical literature),
Root-based functions, e.g.

$$f ( x ) = \frac{a \cdot ( x - b )}{{( \sqrt{c + {\vert x - b \vert}^{d}} )}^{2 / d}} + e \qquad ( Equation 3 )$$

and/or
error functions, e.g.

$$f ( x ) = a \cdot {\int }_{- ∞}^{x} exp ( - b \cdot {( t - c )}^{2} ) d t + d \qquad ( Equation 4 )$$

(as known to the person skilled in the art from standard mathematical literature).

Basically, algorithms are preferred which have a limited number of parameters in order to attain a highly robust estimate for them (e.g. 4 to 6 parameters, as compared to 120 data points in a TaqMan experiment, i.e. 40 cycles with 3 measurements each).

The Gompertz equation is particularly beneficial in this context, as it
(i) has only five parameters, and
(ii) can be used to model non-symmetrical limited growths, as for example represented by PCR curves.

It has the following equation:

f(n)=y₀+r·n+a·exp(−exp(−b·(n−n₀))) (Equation 5)

The five parameters used herein are y₀, r, a, b and n₀, wherein

₀ is the background level
r is the background slope
a is the pedestal (height of saturation level over the background due to exhaustion of substrates or polymerase depletion)
b is a parameter related to the slope (i.e. related to the efficiency of the amplification reaction)
n₀ is the point of inflexion.

Again, background as described by the parameters y₀ and r may be estimated simultaneously to the other parameters or in a separate step.

Similar phenomena are applicable to the above mentioned arcus tangens, tangens Hyperbolicus, Root-based functions, and error functions.

It is furthermore preferred that the said time-related data reflecting the course of the amplification reaction are selected from the group consisting of
fluorescence data, and/or
other measure suitable for reporting the amplification process.

As regards the use of fluorescence data, two approaches are currently in use, i.e.
(i) double-stranded DNA dyes, and
(ii) fluorescent reporter probes.

As regards option (i), double-stranded DNA dyes bind to all double-stranded (ds)DNA in a PCR reaction, whereupon the dyes start to fluoresce when illuminated with a respective excitation light source. An increase in DNA product during PCR therefore leads to an increase in fluorescence intensity and is measured at each cycle, thus allowing DNA concentrations to be quantified. However, the dyes will bind to all dsDNA PCR products, including nonspecific PCR products (such as “primer dimers”). This can potentially interfere with or prevent accurate quantification of the intended target sequence. Like other real-time PCR methods, the values obtained do not have absolute units associated with it (i.e. mRNA copies/cell). A comparison of a measured DNA/RNA sample to a standard dilution will only give a fraction or ratio of the sample relative to the standard, allowing only relative comparisons between different tissues or experimental conditions. To ensure accuracy in the quantification, it is usually necessary to normalize expression of a target gene to a stably expressed gene (see below). This can correct possible differences in RNA quantity or quality across experimental samples.

Dyes used in this approach are, among others, SYBR green, Thiazole orange tetramethylpropane diamine, Thiazole orange tetramethyl diamine, Ethidium propane diamine, Ethidium diethylene triamine, BlueView, Methylene blue, Carolina Blu, and/or DAPI (4′,6-diamidino-2-phenylindole dihydrochloride:hydrate).

The skilled person may easily find more information on the said dyes, including their spectral properties and suitable quenchers, in the respective textbooks, databases and catalogues. Furthermore, the skilled person may as well use other suitable dyes when considering the teaching of the present invention, without the need of inventive step.

In another preferred embodiment, two different dyes are used, i.e. a reference dye and a reporter dye bound to a nucleic acid probe, wherein the latter is combined with a respective quencher. Both dyes have different absorbance spectra and emission spectra, i.e. their concentration can be detected simultaneously, thus enabling real time ratio measurements.

The labelled nucleic acid probes are designed in such a way that they hybridize to at least a section of the target nucleic acid molecule due to base pairing. This means that, while the signal of the reference dye remains more or less constant, the signal of the reporter dye increases proportionally to the number of copied nucleic acid target molecules, as breakdown of the hybridized probes by the 5′ to 3′ exonuclease activity of the Taq polymerase used in the amplification process breaks the reporter-quencher proximity, and thus allows unquenched emission of fluorescence.

Based on the above the following values can be determined in real time:
Rn: fluorescence intensity of the reporter dye/fluorescence intensity of the reference dye
Rn⁺: Rn measured throughout the course of the amplification reaction with template, e.g. three measuring events in a given PCR cycle
Rn⁻: Rn measured before the template (i.e. the target nucleic acid) is added to the reaction mixture (NTC, “no template control”)
ΔRn: Rn⁺−Rn⁻, i.e. the background signal (NTC, “no template control”) is subtracted from the actual signal

The said calculation of Rn (real time ratio calculation) accounts for artifacts caused by fluctuations in excitation light intensity, vibrational noise, detector noise and the like.

The said calculation of ΔRn is an offset subtraction, and accounts for artifacts caused by offset signals, e.g. due to background fluorescence.

TABLE 1

| | | Spectral | Suitable | Spectral |
|---|---|---|---|---|
| dye | function | properties | quencher | properties |
| FAM | reporter | Abs/Em = | BHQ-1 | Abs |
| (Carboxy- | | 492/518 nm | | 480-580 nm |
| fluorescein) | | | | |
| 5-ROX | reference | Abs/Em = | n/n | n/n |
| (Carboxy-X- | | 567/591 nm | | |
| rhodamine) | | | | |

As regards FAM, both 5-Carboxyfluorescein as well as 6-Carboxyfluorescein may be used, while, as regards ROX, both 5-Carboxy-X-rhodamine and 6-Carboxy-X-rhodamine may be used.

Other suitable reporter dyes are, for example, HEX, JOE, VIC, Bodipy TMR, NED, TET, Texas Red, Cy3, Cy3.5, Cy5, Alexa Fluor 647, Alexa Fluor 660, Bodipy 630/650, Pulsar 650, Oregon Green, CalRed, Red640, Rhodamine-6G, JOE, Yakima Yellow, ATTO-TEC, Dragonfly Orange, and/or DYOMICS.

The skilled person may easily find more information on the said dyes, including their spectral properties and suitable quenchers, in the respective textbooks, databases and catalogues. Furthermore, the skilled person may as well use other suitable dyes when considering the teaching of the present invention, without the need of inventive step.

All of the above mentioned reporter dyes may as well be used as reference dyes, if spectral considerations allow.

Suitable quenchers are, for example Tamra, BHQ-2, BHQ-3, NFQ and Dabycl. The skilled person may easily find more information on these quenchers, including their spectral properties, in the respective textbooks, databases and catalogues. Furthermore, the skilled person may as well use other suitable quenchers when considering the teaching of the present invention, without the need of inventive step.

Nucleotide probes comprising both a reporter and a quencher are sometimes termed “Double-Dye Oligonucleotide probes”, also termed “TaqMan Probes”). Usually, the reporter is disposed at the 5′ end while the quencher is disposed at the 3′ end. The common way of depicting such probes is as follows:

5′ [reporter]/3′ [quencher]

The selection of a suitable reporter/quencher combination is, among others, governed by the length of the respective nucleotide probe. Usually, probes with a maximum length of 25 nucleotides are preferred. In case of longer probes two or more quenchers can be used in one nucleotide probe.

In yet another preferred embodiment, the method according to the invention further comprises the step of
g) determining, on the basis of the aforementioned steps, a quantitative value related to the initial concentration or initial number of target molecules in the sample.

An example known in the art is the so-called “Cₜ-Value”. The term “Cₜ-Value” relates to the PCR cycle (“threshold cycle”) in which, for the first time, a signal generated by the number of copies produced in the amplification process is being detected at a pre-defined threshold. As it is highly unlikely that this pre-defined threshold value is exactly met, interpolation of the signal intensities (and in turn the detected copy numbers) is used between neighboring cycles. This means that, due to interpolation, the Cₜ-Value may in most cases not be an integer, but a fractional value.

The higher the Cₜ value is; the lower the initial concentration of the target to be determined in the probe was. A sample the Cₜ of which is reached 3 cycles earlier than another's has thus 2³=8 times higher initial target concentration (provided the amplification reaction has been 100% efficient, i.e. perfect theoretical amplification).

The process is subject to the following equation

cᵢ=c₀×2ⁱ (Equation 6)

in which
i is the cycle number
c₀ is the initial target copy number, and
cᵢ is the total number of target molecules after i cycles of the amplification process

Given an initial target copy number c₀ of 0.1 nM and a number of 30 cycles (i=30), the number of copies produced after 30 cycles is thus 107.37 mM, provided an efficiency of 100% (see above).

The determination of the Cₜ value is thus a useful tool for quantitation of the initial concentration of the target to be determined in the probe.

An overview over the exact procedure of how to determine the Cₜ value is given in FIG. 11, and the respective description. It is obvious that the quantitation must be done
(i) in a phase where the amplification is exponential, and
(ii) at the very beginning of the exponential phase, not in what appears to be the constant region of the curve.

It should also be noted that samples that differ from the optimal amplification factor of 2 are expected to deviate from the theoretical Cₜ value. This can be corrected mathematically by using a model or by measurements if known concentrations are used as calibrators.

In yet another preferred embodiment, the method according to the invention further comprises the step of
h) determining, on the basis of the aforementioned steps, the C_{P} value of the nucleic acid amplification reaction.

The term “C_{P} value” stands for “crossing point” value and—as the C_{T} value—is a value that allows quantification of input target RNA. It is provided by the LightCycler instrument offered by Roche by calculation according to the second-derivative maximum method.

The original C_{P} method is based on a locally defined, differenciable approximation of the intensity values, e.g. by a polynomial function. Then the third derivative is computed. The CP value is the smallest root of the third derivative. These computations are easily carried out by any person skilled in the art.

An overview over the exact procedure of how to determine the C_{P} value is given in FIG. 12, and the respective description.

In yet another preferred embodiment, the method according to the invention further comprises the step of
i) determining, on the basis of the aforementioned steps, the BV value of the nucleic acid amplification reaction.

The BV (“Backtracking Value”),or Cy0 value (Guescini 2008), is computed by intersecting the straight line that is the tangent to the point of inflexion with the background. Again, if a local or global differenciable approximation of the intensity curve is given, this can be easily computed by a person skilled in the art.

An overview over the exact procedure of how to determine the BV value is given in FIG. 13, and the respective description.

Disclaimer

To provide a comprehensive disclosure without unduly lengthening the specification, the applicant hereby incorporates by reference each of the patents and patent applications referenced above.

The particular combinations of elements and features in the above detailed embodiments are exemplary only; the inter-changing and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

### EXAMPLE

Table 2 shows data as obtained in a Real Time PCR (taq man) experiment. As in each cycle three measurements are being made both for the reference dye and the reporter dye, three ratio values are then caluculated, which serve then for caluclation a mean ratio value for each cycle. The latter is then plotted vs. cycle number in order to obtain a PCR curve (see FIG. 14).

The actual process is as follows:
a. Choose one well of a micottiter plate to be investigated
b. Check if data reflecting the time course odf the experiment (e.g. fluorescence data) are available (if not: investigation can't be done).
c. Check if there are three measurements for each of the 40 TaqMan cycles (if not: investigation can't be done).
d. For each of the 40 cycles and each of the three measurements per cycle, compute the Fam/Rox ratio (see table 2).
e. For each of the 40 cycles, compute the mean value of Fam/Rox of the three measurements for this cycle (see table 2), and plot these data vs cycle number (see FIG. 14). Alternatively, one may first average over the three measurements for Fam per cycle and the three measurements for Rox per cycle and compute the quotient Fam/Rox afterwards, thus swapping the last two steps.

TABLE 2

| | Fam | | | Rox | | | Fam/Rox ratio | | | Fam/Rox |
|---|---|---|---|---|---|---|---|---|---|---|
| Cycle | first | second | third | first | second | third | first | second | third | ratio mean |
| 1 | 901.085 | 893.823 | 894.487 | 1918.121 | 1914.164 | 1937.292 | 0.470 | 0.467 | 0.462 | 0.466 |
| 2 | 926.472 | 909.891 | 895.743 | 1912.466 | 1924.263 | 1922.480 | 0.484 | 0.473 | 0.466 | 0.474 |
| 3 | 933.123 | 939.563 | 932.894 | 1921.880 | 1918.765 | 1915.983 | 0.486 | 0.490 | 0.487 | 0.487 |
| 4 | 903.897 | 887.803 | 922.271 | 1895.183 | 1892.782 | 1924.483 | 0.477 | 0.469 | 0.479 | 0.475 |
| 5 | 939.339 | 911.103 | 917.913 | 1909.378 | 1891.962 | 1888.445 | 0.492 | 0.482 | 0.486 | 0.487 |
| 6 | 921.229 | 918.379 | 938.226 | 1879.856 | 1891.906 | 1896.175 | 0.490 | 0.485 | 0.495 | 0.490 |
| 7 | 946.622 | 921.320 | 910.561 | 1887.342 | 1894.120 | 1897.118 | 0.502 | 0.486 | 0.480 | 0.489 |
| 8 | 971.627 | 940.833 | 929.001 | 1894.893 | 1884.977 | 1891.925 | 0.513 | 0.499 | 0.491 | 0.501 |
| 9 | 925.304 | 921.440 | 938.721 | 1873.741 | 1868.204 | 1870.196 | 0.494 | 0.493 | 0.502 | 0.496 |
| 10 | 942.986 | 959.993 | 932.387 | 1876.462 | 1891.589 | 1872.973 | 0.503 | 0.508 | 0.498 | 0.503 |
| 11 | 955.816 | 933.759 | 963.820 | 1859.383 | 1866.179 | 1894.770 | 0.514 | 0.500 | 0.509 | 0.508 |
| 12 | 970.276 | 968.935 | 953.271 | 1892.724 | 1884.704 | 1871.591 | 0.513 | 0.514 | 0.509 | 0.512 |
| 13 | 959.695 | 926.347 | 950.095 | 1847.153 | 1844.248 | 1856.255 | 0.520 | 0.502 | 0.512 | 0.511 |
| 14 | 958.544 | 963.573 | 956.251 | 1886.076 | 1854.880 | 1862.819 | 0.508 | 0.519 | 0.513 | 0.514 |
| 15 | 968.877 | 923.341 | 926.590 | 1857.470 | 1846.076 | 1839.776 | 0.522 | 0.500 | 0.504 | 0.508 |
| 16 | 965.465 | 950.038 | 978.817 | 1847.125 | 1836.265 | 1858.612 | 0.523 | 0.517 | 0.527 | 0.522 |
| 17 | 971.262 | 964.640 | 946.663 | 1859.851 | 1844.159 | 1846.556 | 0.522 | 0.523 | 0.513 | 0.519 |
| 18 | 955.444 | 962.709 | 961.532 | 1823.910 | 1845.896 | 1859.825 | 0.524 | 0.522 | 0.517 | 0.521 |
| 19 | 978.776 | 964.058 | 946.658 | 1842.174 | 1858.148 | 1851.057 | 0.531 | 0.519 | 0.511 | 0.521 |
| 20 | 980.712 | 988.603 | 922.547 | 1820.480 | 1839.394 | 1818.675 | 0.539 | 0.537 | 0.507 | 0.528 |
| 21 | 953.337 | 974.942 | 952.434 | 1817.607 | 1841.595 | 1833.533 | 0.525 | 0.529 | 0.519 | 0.524 |
| 22 | 970.435 | 947.218 | 947.062 | 1828.257 | 1811.634 | 1817.882 | 0.531 | 0.523 | 0.521 | 0.525 |
| 23 | 986.366 | 967.263 | 977.456 | 1828.069 | 1826.150 | 1836.002 | 0.540 | 0.530 | 0.532 | 0.534 |
| 24 | 948.690 | 986.003 | 963.526 | 1810.843 | 1827.307 | 1844.513 | 0.524 | 0.540 | 0.522 | 0.529 |
| 25 | 985.665 | 983.533 | 960.591 | 1834.905 | 1834.671 | 1812.419 | 0.537 | 0.536 | 0.530 | 0.534 |
| 26 | 993.633 | 991.587 | 997.000 | 1818.861 | 1824.584 | 1821.436 | 0.546 | 0.543 | 0.547 | 0.546 |
| 27 | 984.617 | 1013.280 | 1012.755 | 1807.640 | 1815.683 | 1828.031 | 0.545 | 0.558 | 0.554 | 0.552 |
| 28 | 991.695 | 1007.071 | 1037.265 | 1804.858 | 1812.383 | 1829.167 | 0.549 | 0.556 | 0.567 | 0.557 |
| 29 | 1061.435 | 1046.206 | 1055.517 | 1819.092 | 1814.683 | 1830.762 | 0.583 | 0.577 | 0.577 | 0.579 |
| 30 | 1091.233 | 1071.844 | 1059.226 | 1821.555 | 1801.451 | 1766.463 | 0.599 | 0.595 | 0.600 | 0.598 |
| 31 | 1176.233 | 1157.929 | 1178.991 | 1806.232 | 1800.603 | 1803.078 | 0.651 | 0.643 | 0.654 | 0.649 |
| 32 | 1293.330 | 1301.186 | 1313.605 | 1797.047 | 1806.587 | 1796.852 | 0.720 | 0.720 | 0.731 | 0.724 |
| 33 | 1539.028 | 1527.562 | 1547.507 | 1812.499 | 1786.678 | 1790.882 | 0.849 | 0.855 | 0.864 | 0.856 |
| 34 | 1916.092 | 1954.595 | 1974.686 | 1781.413 | 1794.850 | 1792.142 | 1.076 | 1.089 | 1.102 | 1.089 |
| 35 | 2462.162 | 2577.425 | 2609.471 | 1768.660 | 1774.418 | 1794.377 | 1.392 | 1.453 | 1.454 | 1.433 |
| 36 | 3249.757 | 3329.566 | 3427.062 | 1781.127 | 1749.346 | 1767.348 | 1.825 | 1.903 | 1.939 | 1.889 |
| 37 | 4091.109 | 4267.730 | 4280.648 | 1782.593 | 1794.280 | 1741.023 | 2.295 | 2.379 | 2.459 | 2.377 |
| 38 | 4924.700 | 5090.482 | 5182.704 | 1761.970 | 1756.178 | 1775.049 | 2.795 | 2.899 | 2.920 | 2.871 |
| 39 | 5724.392 | 5826.444 | 5917.400 | 1778.034 | 1763.299 | 1786.489 | 3.220 | 3.304 | 3.312 | 3.279 |
| 40 | 6352.396 | 6451.959 | 6561.386 | 1777.743 | 1779.196 | 1770.610 | 3.573 | 3.626 | 3.706 | 3.635 |

f. Determine the linear region of the curve (see FIG. 5). For this purpose, perform a linear regression on the interval [b0,b1] for each possible choice of (b0,b1) where 2≦b0≦4 and b0+4≦b1≦40. The 90% two-sided confidence interval for the slope of the regression line is defined as

[slope−t_{0.95}·SE(slope), slope+t_{0.95}·SE(slope)], (Equation 7)

where t_{0.95} is the appropriate quantile of Student's t distribution with 38 (=40-2) degrees of freedom and SE(slope) is the standard error for the slope (see Altman et al., 2000) to determine the linear region of the curve, compute the length of the confidence interval and choose the pair (b0*,b1*) for which this length is the smallest. The corresponding tables (table 3) and plots (FIG. 19) show that in this example, a choice of b0*=2 and b1*=28 is best. Therefore, the linear region of the curve is the interval [2 28]. The background of the whole curve is estimated as y0+r·n, where y0 and r are the intercept and the slope of the regression line over the cycle interval [b0*b1*] and n is the cycle number. In this example, the linear function is determined as 0.473513+0.002675×n.

TABLE 3

| | Length of confidence intervals | | |
|---|---|---|---|
| Cycle No. | 2 | 3 | 4 |
| 6 | 0.009587863 | n/a | n/a |
| 7 | 0.005759298 | 0.009116752 | n/a |
| 8 | 0.004308299 | 0.006383144 | 0.005774303 |
| 9 | 0.003186195 | 0.004345624 | 0.004529944 |
| 10 | 0.002409696 | 0.003137894 | 0.003066401 |
| 11 | 0.001905919 | 0.002409547 | 0.002203898 |
| 12 | 0.001552063 | 0.001917903 | 0.001665497 |
| 13 | 0.00129346 | 0.001558662 | 0.00141441 |
| 14 | 0.001100136 | 0.001296864 | 0.001215733 |
| 15 | 0.00111857 | 0.001285769 | 0.001377325 |
| 16 | 0.000974834 | 0.001112562 | 0.001164459 |
| 17 | 0.000863878 | 0.000971768 | 0.001023788 |
| 18 | 0.000778289 | 0.000862935 | 0.000917082 |
| 19 | 0.000727502 | 0.000795246 | 0.000857228 |
| 20 | 0.000648834 | 0.000703784 | 0.000753372 |
| 21 | 0.000612688 | 0.00065714 | 0.000709703 |
| 22 | 0.000587682 | 0.00062348 | 0.000678317 |
| 23 | 0.000532907 | 0.000562624 | 0.000608233 |
| 24 | 0.000513564 | 0.000537626 | 0.000583239 |
| 25 | 0.000473781 | 0.000492724 | 0.000533346 |
| 26 | 0.000449277 | 0.000470023 | 0.000505169 |
| 27 | 0.00044255 | 0.000467382 | 0.000498481 |
| 28 | 0.000440748 | 0.000468691 | 0.000496616 |
| 29 | 0.000574771 | 0.00061784 | 0.000654131 |
| 30 | 0.000762821 | 0.000820837 | 0.000867819 |
| 31 | 0.001272109 | 0.001362632 | 0.001445188 |
| 32 | 0.002074152 | 0.002211745 | 0.002344667 |
| 33 | 0.003425583 | 0.003639499 | 0.003856052 |
| 34 | 0.005705517 | 0.006041425 | 0.006394855 |
| 35 | 0.009007112 | 0.009520066 | 0.010055726 |
| 36 | 0.013253863 | 0.013976707 | 0.014744006 |
| 37 | 0.017836047 | 0.018753512 | 0.019739249 |
| 38 | 0.022351723 | 0.02344579 | 0.024605617 |
| 39 | 0.02617885 | 0.027409693 | 0.028694184 |
| 40 | 0.029284767 | 0.030569225 | 0.031940526 |

g. To decide if there is a detectable signal at all, a threshold is calculated by determining the standard deviation of ΔRn (=Fam/Rox−background estimation) on the interval [b0*b1*] and multiplying it with 10. In the example, the threshold is 0.0512. If there is a b≧b1* for which LRn(b) is bigger than the threshold, it is assumed that there is a detectable signal. In the example, this is the case, as it can easily be seen in FIG. 5.
h. The next step is the fitting the sigmoid part of the curve. This is done by fitting ΔRn on the interval [b1*−5, 40] with the Gompertz function

f(n)=a·exp(−exp(−b·(n−n₀))) (Equation 8)

(Note that, since the background was fitted separately, and consequently used in the computation of ΔRn), only the stripped model without the linear part with its parameters y0 and r is used here)

where a, b and n₀ are the fitting parameters as described above and n is the cycle number. In this example, one computes a=4.853471, b=0.261715 and n₀=36.982872 as the optimal choice of parameters that minimizes

$${\sum }_{n} {( f ( n ; a , b , {n}_{0} ) - Δ {R}_{n} ( n ) )}^{2} {}^{!} {min}_{a , b , {n}_{0}} \qquad ( Equation 9 )$$

i. If the nonlinear optimization process fails to converge, reject the curve as “invalid”. This is not the case in the given example as the optimization was successful.
j. Having obtained these parameters, the parameters are checked for curve validity (rough rules and fine rules, see above). It is then assessed if the defined quality criteria are met. This is the case for the given example.
k. From the parameters, a quantitative value such as the C_{P} Value and the BV Value can be computed by the formulas mentioned above. For the given example, BV=33.16 and C_{P}=33.31.

### BRIEF DESCRIPTION OF THE DRAWINGS

FIG. 1 shows a typical PCR curve in which ΔRn (Fam/Rox, see above) is plotted vs. cycle number. The curve has passed the visual curve inspection as outlined above. The curve has the typical sigmoidal shape, the S/N is acceptable and the three different phases are easy to distinguish.

The horizontal line illustrates a choice for the threshold value to obtain a Cₜ Value. The fractional cycle number at the point of intersection in the vicinity of 27.5 is the Cₜ Value. (Screenshot from SDS Software 2.3, ABI)

FIG. 2 shows an example for a PCR curve which is subject to errors and artifacts, and has thus not passed the visual curve inspection as outlined above (classified as “crawler”), due to the fact that S/N was poor high and the different phases could not be identified.

However, the inventors have found that the curve shown in FIG. 2 was classified as successful by the automatic solutions as mentioned in the introduction, although it would not pass the visual curve inspection.

FIG. 3 shows the time course of a successful PCR experiment (TaqMan experiment with Double-Dye Oligonucleotide probes), in which Rn+ (Fam/Rox, see above) is plotted vs. the PCR cycle number. The curve has the typical sigmoidal shape, the S/N is good and the three different phases are easy to distinguish.

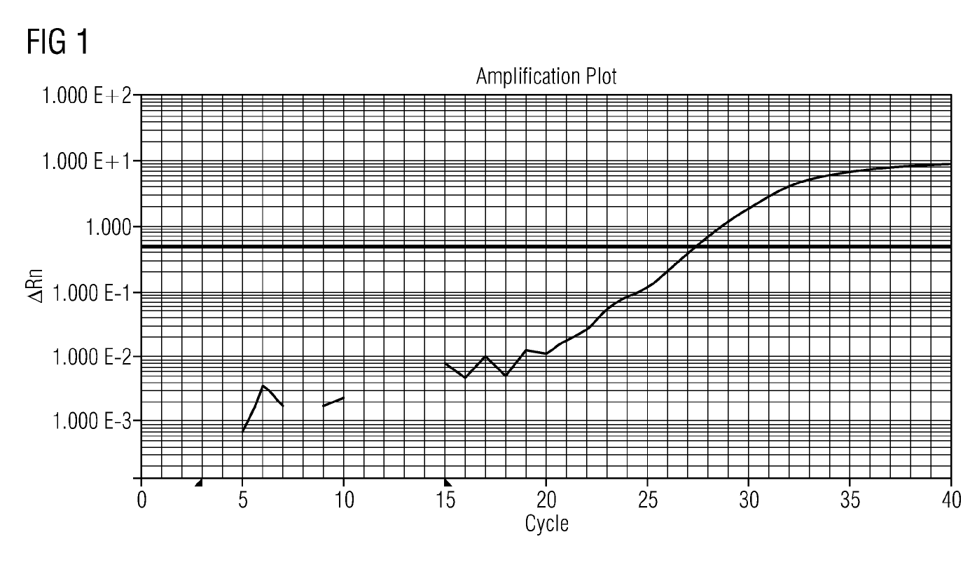

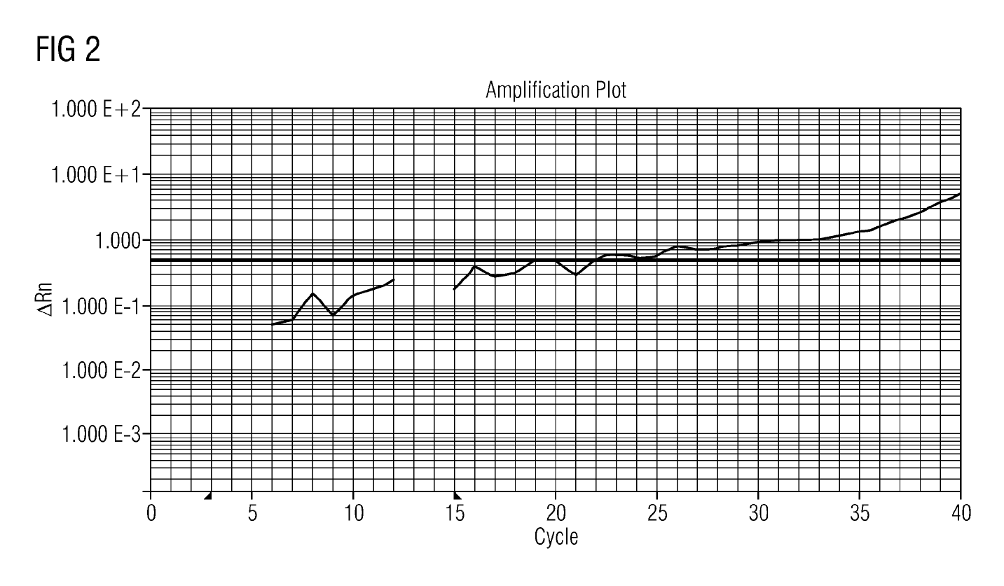

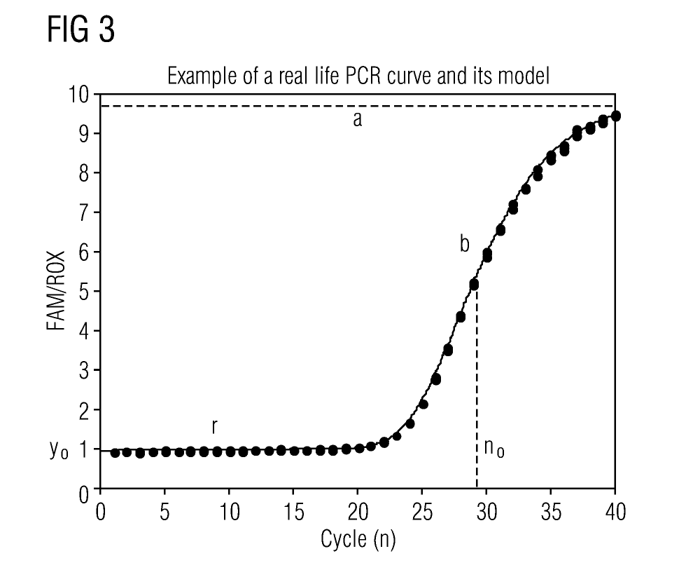

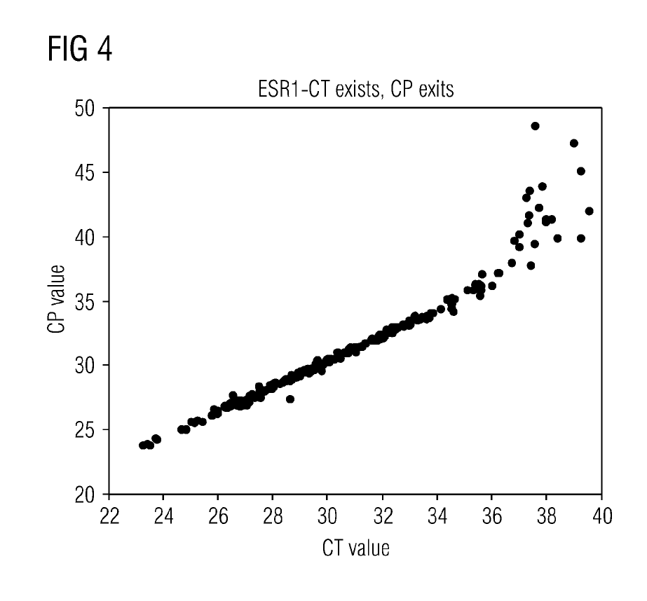

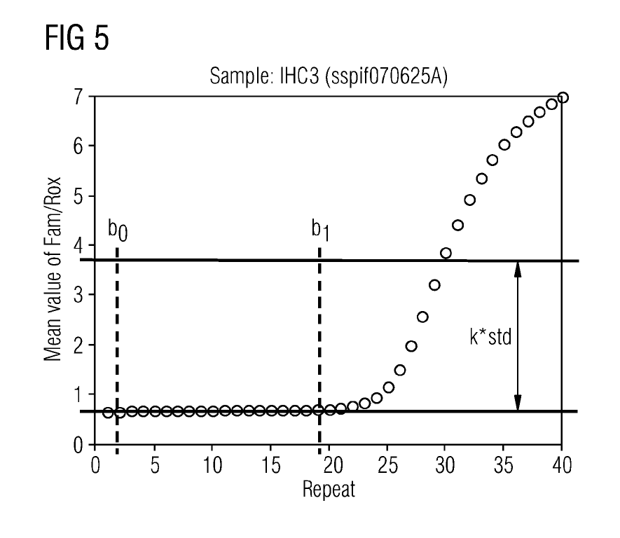

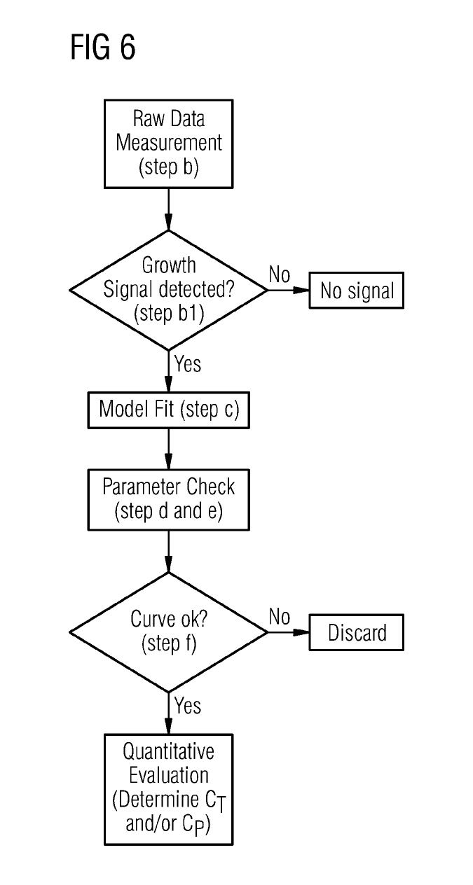

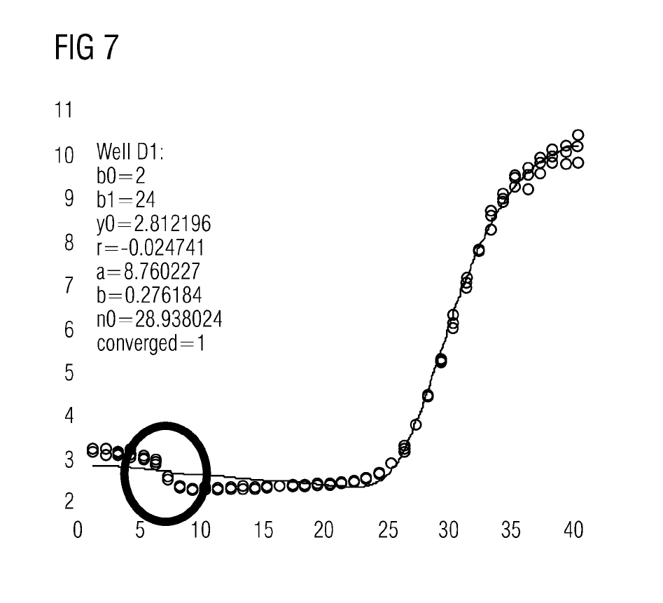

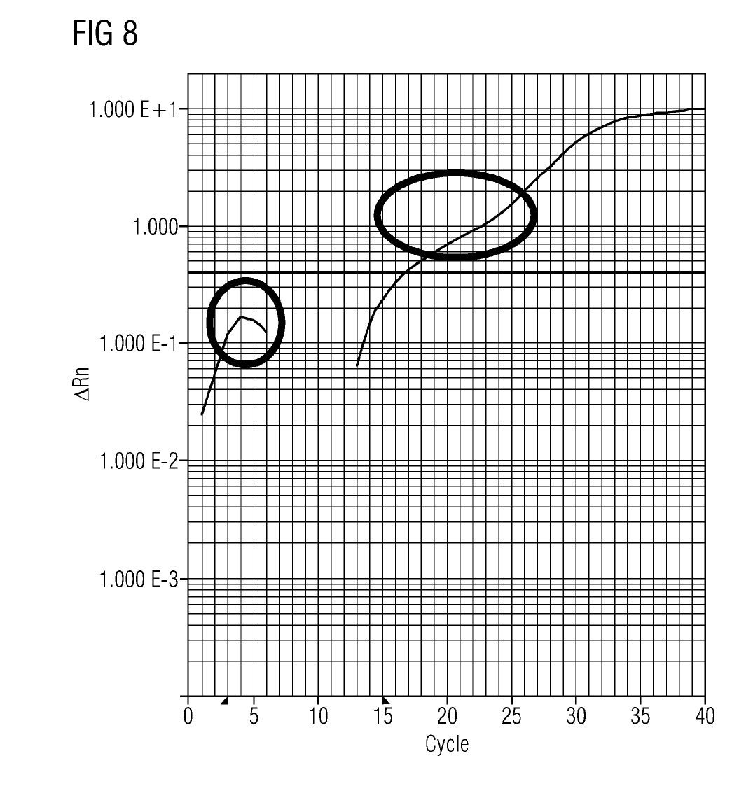

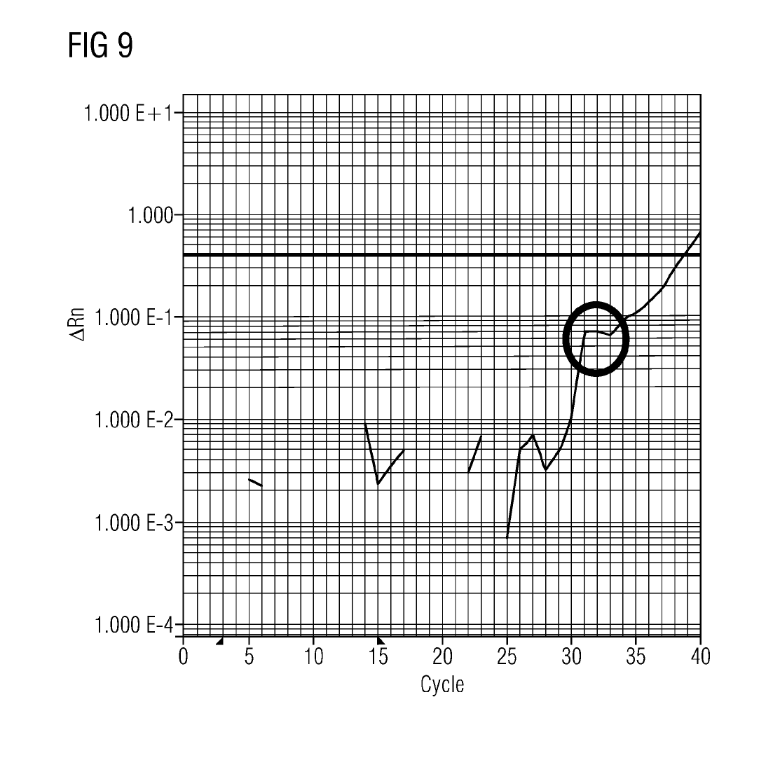

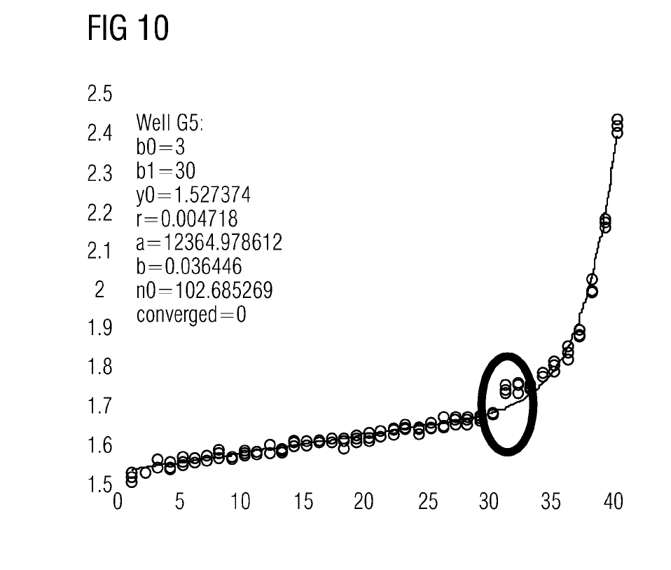

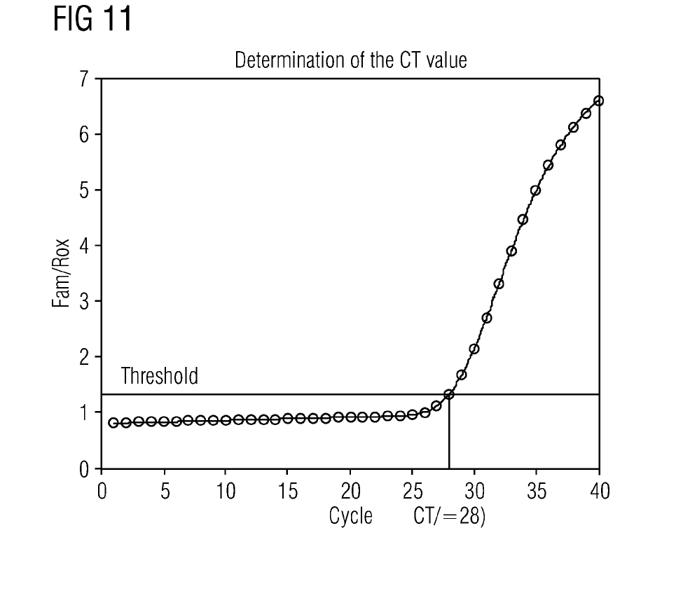

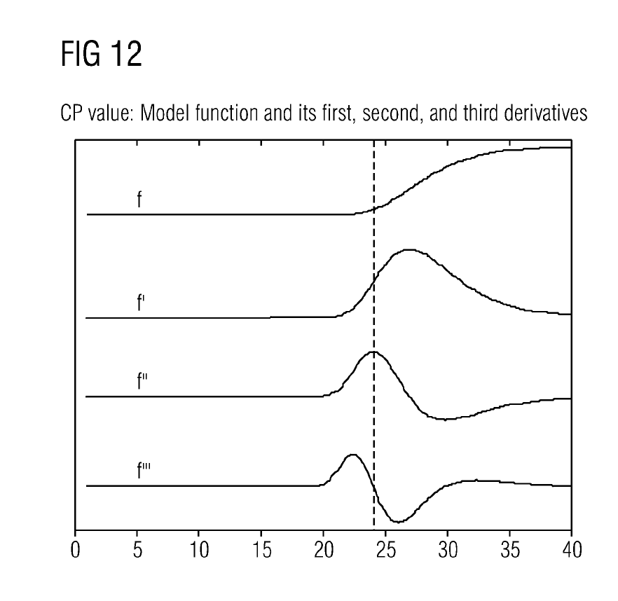

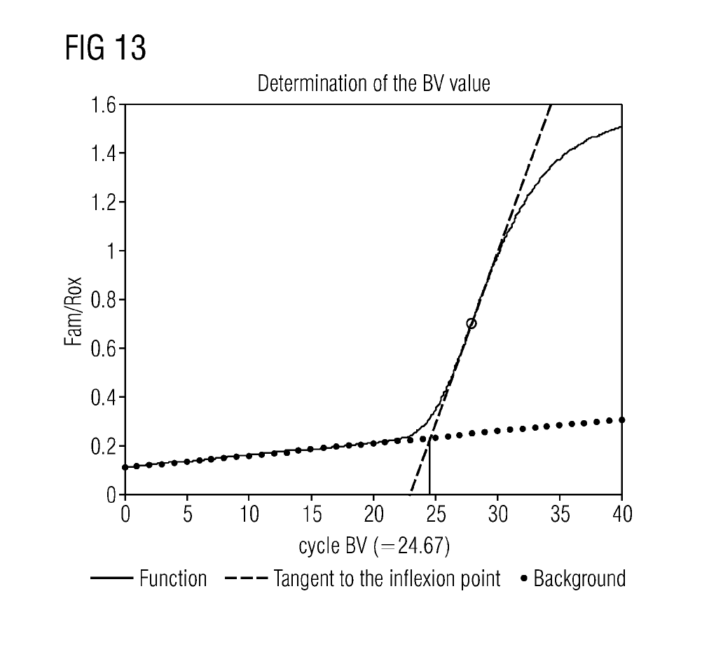

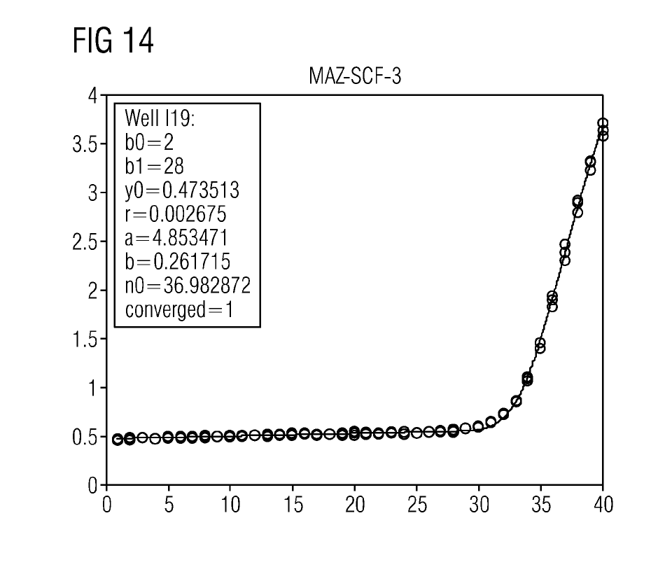

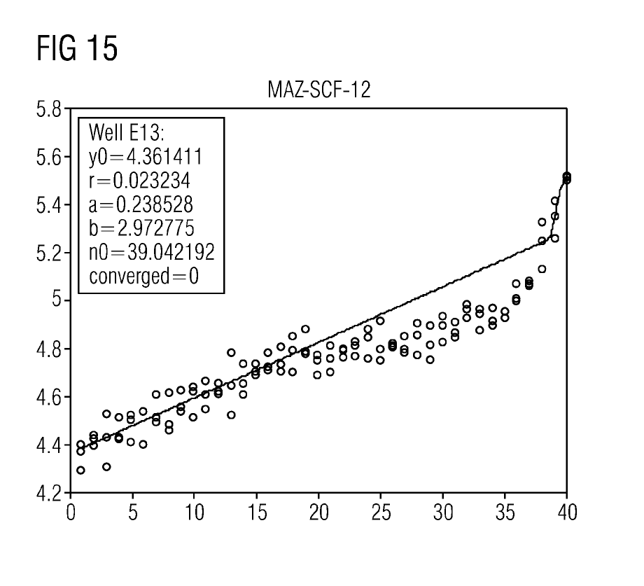

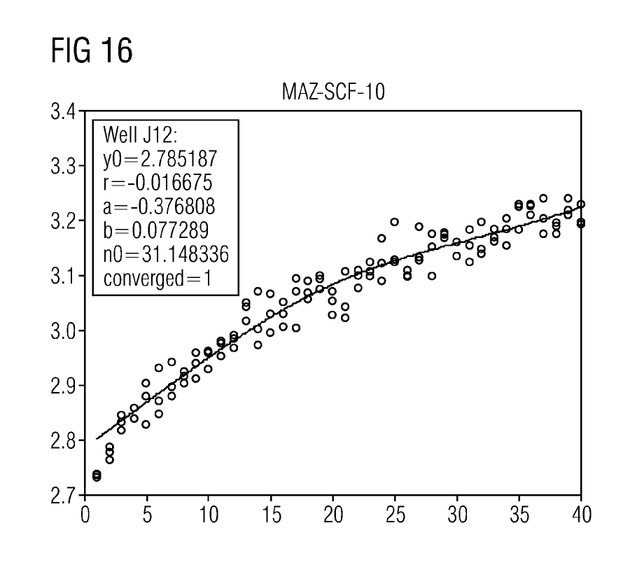

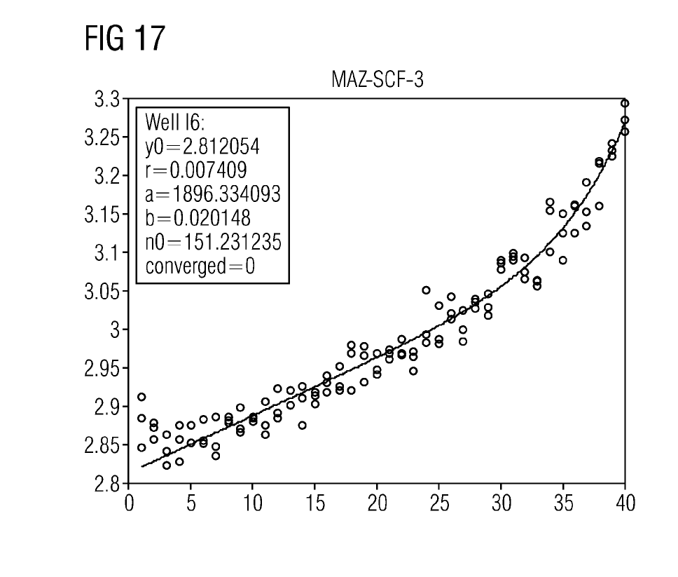

Please note that, while in the TaqMan approach three data points are measured per PCR cycle, only one value per cycle is indicated in the plot (Rn+), see above) (measurements averaged for each well and each cycle).

The PCR curve has then been fitted with a Gompertz equation of the following kind:

f(n)=y₀+r·n+a·exp(−exp(−b·(n−n₀))) (Equation 10)

according to the method as set forth in the present invention.

The parameters of the Gompertz equation are indicated in the figure, wherein
y₀ is the background level
r is the background slope
a is the pedestal (height of saturation level over the background due to exhaustion of substrates or polymerase depletion)
b is related to the slope (i.e. is related to the efficiency of the amplification reaction)
n₀ is the point of inflexion.

It is obvious that the fit does faithfully reflect the time course of the PCR curve.

Given the five parameters, one can then decide wether or not the curve passes quality control by comparing the parameter values to sets of so-called (i) rough rules and/or (ii) fine rules.

“Rough rules”, as used herein, are rules which check if the parameter values make sense at all due to biochemical considerations (plausibility check).

For the parameters of the Gompertz equation, a possible choice of rough rules is the following (in which “>” means “must be greater than”, “<” means “must be smaller than”, “≧” means “must be greater than or equal to” and “≦” means “must be smaller than or equal to”):

TABLE 4

| parameter | preferred value |
|---|---|
| y₀ | >0 |
| r | >0 |
| a | >0 |
| b | >0 |
| n₀ | ≦45 |
| n₀ | >0 |

“Fine rules”, as used herein, are optional rules by which the allowed range of one or more of the five parameters can be reduced.

They are being derived by observing parameter variation for a number of PCR runs known to be valid (as assessed e.g. by visual inspection by an expert, as outlined above). It is furthermore possible that fine rules depend on the reagents being used (e.g. primer/probe set, production lot)

A curve passes quality control if all of the five parameters lie in their respective allowed ranges.

In a preferred embodiment of the method, there no fine rules are being used (for sake of simplicity, i.e. the above mentioned rough rules are considered sufficient to determine whether or not an experiment passes QC.

In a more preferred embodiment, the fine rules do not depend on the reagents.

In more preferred embodiments, a choice of fine rules independent of the reagents is the following (in which “>” means “must be greater than”, “<” means “must be smaller than”, “≧” means “must be greater than or equal to” and “≦” means “must be smaller than or equal to”):

TABLE 5

| | preferred | more preferred | even more |
|---|---|---|---|
| parameter | value | value | preferred value |
| y₀ | ≦10 | ≦6 | ≦4 |
| y₀ | ≧0.5 | ≧1 | |
| r | ≦0.05 | ≦0.03 | ≦0.02 |
| a | ≦100 | ≦20 | ≦10 |
| b | ≦1 | ≦0.05 | ≦0.04 |
| b | ≧0.01 | ≧0.015 | |

For Arcus tangens, Tangens Hyperbolicus, Root-based functions, and/or error functions similar rules apply.

FIG. 4 shows a plot of C_{T}-Values as determined with a standard C_{T}-Value method as provided by SDS Software 2.3, ABI, vs. C_{P}-Values as determined according to the invention (Gompertz algorithm). See FIG. 12 for a description on how the C_{P}-Values are determined. It is obvious that there is a good correlation between both values.

FIG. 5 shows an approach for the determination whether or not the time-related data collected do at all reflect a growth, i.e. whether or not there is an amplification-related signal at all.

This approach (termed step bi) takes, optionally, place between steps b) and c) of the method according to the invention.

In this approach, it is checked whether or not there is a significant increase of time-related data over time, which might reflect a limited or non-limited growth of target nucleic acid as produced by a nucleic acid amplification process. If not, it is assumed that there the nucleic acid amplification reaction was not successful at all, and the curve fitting approach as outlined above is not necessary.

For this purpose, one can, as shown in FIG. 5,
(i) determine one value for Fam/Rox for each cycle by averaging over the three measurements per cycle
(ii) perform a linear regression on the interval [b₀ b₁] for each choice of 2≦b₀≦4 and b₀ +4≦b₁≦40.
(iii) compute the length of the confidence interval for the slope of the regression line for each choice of the pair (b₀,b₁)
(iv) determine the pair (b₀*,b₁*) for which the confidence interval size is the smallest.
(v) determine a threshold by computing the standard deviation of LRn on [b₀*b₁*] and multiplying it with a constant, e.g. 10.

In this example, a signal is assumed to exist if there is a b≧b₁ with Rn(b)>threshold. If the latter is not the case, it is assumed that there is no amplification related signal.

FIG. 6 shows a flowchart of the different steps (some of them optional) of the method according to the invention.

FIGS. 7-10 give other examples for PCR curves which did not pass the visual quality control, while they were classified as successful by the automatic solutions as mentioned in the introduction

FIG. 11 gives an impression of how the C_{T}-Value is determined. The term “C_{T}-Value” relates to the PCR cycle (“threshold cycle”) in which, for the first time, a signal generated by the number of copies produced in the amplification process is being detected at a pre-defined threshold. For this purpose, a threshold value is determined, and the cycle number is determined for which the curve fitted with the above equation intersects with the threshold. As it is highly unlikely that this pre-defined threshold value is exactly met, interpolation of the signal intensities (and in turn the detected copy numbers) is used between neighbouring cycles. This means that, due to interpolation, the C_{T}-Value may in most cases not be an integer, but a fraction number.

FIG. 12 gives an overview of how the C_{P}-Value is determined. The term “C_{P}-Value” stands for “crossing point” value and—as the C_{T}-Value - is a value that allows quantification of input target RNA.

The C_{P} approach is based on a locally defined, differentiable approximation of the intensity values, e.g. by a polynomial function. Then the third derivative is computed. The C_{P}-Value is the smallest root of the third derivative. These computations are easily carried out by any person skilled in the art.

FIG. 13 gives an overview of how the BV-Value is determined. In order to do so, a tangent is drawn to the point of inflexion (i.e. linear function with the same function value and first derivative value of the curve fitted with the above equation evaluated at the point of inflexion). Then, the time course of the background signal is extrapolated, and the intersection between both curves is determined. The respective cycle number reflecting the BV-Value is then determined by interpolation.

FIG. 14 gives an example for a curve fitting process with a Gompertz equation which confirmed that the underlying PCR curve was not error-prone (Quality control passed). The underlying data have been discussed above.

FIGS. 15-17 give examples for curve fitting processes with a Gompertz equation which showed that the underlying PCR curve was error-prone (Quality control not passed).

In FIG. 15, the value for the parameter “r” is too high (0.023234 instead of <0.02, see fine rules in table 5). In

FIG. 16, the value for the parameter “a” is too small (−0.3768 instead of >0, see rough rules in table 4). Iₙ FIG. 17, the value for the parameter “n₀” is too high. (151.23 instead of ≦45, rough rules in table 4).

### LIST OF REFERENCES

Xinyou Yin, Jan Goudriaan, Egbert A. Lantinga, Jan Vos and Huub J. Spiertz: A Flexible Sigmoid Function of Determinate Growth, Annals of Botany 91,361-371, 2003)
Douglas G Altman, David Machin, Trevor N Bryant, Martin J Gardner: Statistics with confidence 2^{nd} edition, BMJ Books, 2000).
Michele Guescini, Marco B L Rocchi, Laura Stocchi, Vilberto Stocchi : A new real-time PCR method to overcome significant quantitative inaccuracy due to slight amplification inhibition. BMC Bioinformatics 2008, 9:326

1. A method for the quality assessment of nucleic acid amplification reactions, comprising the following steps:
a) Carrying out an amplification reaction for at least one nucleic acid target molecule,
b) Collecting time-related data reflecting the course of the amplification reaction,
c) Fitting these time-related data with a growth model equation comprising at least one parameter,
d) Obtaining, from said fitting process, at least one value for the at least one parameter.

2. The method according to claim 1, further comprising the steps of:
e) comparing the at least one value of the at least one parameter with at least one threshold value for the at least one parameter, and
(f) determining, on the basis of step e), whether or not the said nucleic acid amplification reaction meets at least one quality criterion.

3. The method according to claim 1, further comprising the step of:
b1) determining, between steps b) and c), whether or not the time-related data collected reflect a growth.

4. The method according to claim 1, wherein the nucleic acid amplification reaction is at least one reaction selected from the group consisting of
Real time Polymerase Chain reactions,
reverse transcription Polymerase Chain Reactions,
Ligase Chain Reaction (LCR),
Nucleic Acid Sequence Based Amplification (NASBA),
Transcription Mediated Amplification (TMA),
Rolling Circle Chain Reaction (RCCR), or Rolling circle Amplification (RCA) and/or
other kinetic or quantitative amplification reactions with real time read-out.

5. The method according to claim 1, wherein the growth model is at least one selected from the group consisting of
non-limited growth models, and/or
limited growth models.

6. The method according to claim 1, wherein the limited growth model is a non-symmetrical limited growth model.

7. The method according to claim 1, wherein the limited growth model is based on at least one algorithm selected from the group consisting of
Gompertz equation,
Arcus tangens and/or Tangens Hyperbolicus,
Root-based functions, and/or
error functions.

8. The method according to claims claim 1, wherein the time-related data reflecting the course of the amplification reaction or selected from the group consisting of
fluorescence data, and
other measure suitable for reporting the amplification process.

9. The method according to claim 7, further comprising the step of:
g) determining, on the basis of the aforementioned steps, a quantitative value related to the initial concentration or initial number of target molecules in the sample.

10. The method according to claim 7, further comprising the step of:
h) determining, on the basis of the aforementioned steps, the Cp value of the nucleic acid amplification reaction.

11. The method according to claim 7, further comprising the step of:
i) determining, on the basis of the aforementioned steps, the BV value of the nucleic acid amplification reaction.
